(19) United States
(12) Patent Application Publication
(10) Pub. No.: US 2024/0053171 A1
(43) Pub. Date: Feb. 15, 2024

(54) INDUCTIVE SENSOR ASSEMBLY

(71) Applicant: Renesas Electronics America Inc., Milpitas, CA (US)

(72) Inventors: Bence GOMBOR, Budapest (HU); Gentjan QAMA, Munchen (DE); Rudolf PICHLER, Stallhofen (AT)

(73) Assignee: Renesas Electronics America Inc., Milpitas, CA (US)

(21) Appl. No.: 18/446,608

(22) Filed: Aug. 9, 2023

Related U.S. Application Data
(60) Provisional application No. 63/396,314, filed on Aug. 9, 2022.

(30) Foreign Application Priority Data
Mar. 21, 2023 (DE) 102023202516.7

(51) Int. Cl. G01D 5/20

(52) U.S. Cl. CPC G01D 5/2053

(57) ABSTRACT

An inductive sensor assembly including a printed circuit board (PCB) arrangement including at least one layer-stacked PCB, a sensor chip component element, a coil system comprising one or more sensor coils corresponding to the sensor chip component element, wherein the sensor chip component element and the coil system are arranged on opposite sides of the PCB arrangement.

### CROSS-REFERENCE TO RELATED APPLICATIONS

The subject application claims the benefit of U.S. Provisional Patent Application No. 63/396,314, filed on Aug. 9, 2022. The entire disclosure of U.S. Provisional Patent Application No. 63/396,314 is incorporated by this reference. The subject application claims priority under 35 U.S.C. § 119 to German Patent Application No. 102023202516, filed on Mar. 21, 2023. The entire disclosure of German Patent Application No. 102023202516 is incorporated by this reference.

### TECHNICAL FIELD

The present disclosure is generally directed to techniques related to inductive sensor assembly, and more particularly to techniques related to inductive ring shape sensor assembly.

### BACKGROUND

In a broad sense, techniques related to inductive sensors or inductive sensor assembly are widely used in various technologies, e.g., in automotive fields. Therein, particularly within the technical context of the present disclosure, inductive position sensors may be considered reasonably popular, generally because of their robustness against environmental influences, for example. Especially for through-shaft applications, the inductive sensors may be considered attractive because of the design flexibility in coil design, which generally allows for relatively easy adaptation for example for on-axis and off-axis position sensing applications.

Although these benefits may in some cases be seen as a big advantage in many industrial or automotive applications, often for such as industrial or robotics applications, a higher output resolution would be needed which only one absolute inductive position sensor might not be capable of. In addition, some automotive applications may require absolute high-resolution sensors as well, like steering sensors or sensors for wheel hub traction motors, etc.

In view thereof, broadly speaking, the focus of the present disclosure is to propose techniques and/or mechanisms for improvement in design and/or manufacturing of inductive sensor assembly, and more particularly, in a compact and space efficient manner.

### SUMMARY

In view of some or all of the above technical problems, broadly speaking, the present disclosure generally provides an inductive sensor assembly and a method for manufacturing an inductive sensor assembly, having the features of the respective independent claims.

According to an aspect of the disclosure, there is provided an inductive sensor assembly (or sometimes also referred to as a sensor design, setup, implementation, or the like).

In particular, the inductive sensor assembly may comprise a printed circuit board (PCB) arrangement comprising at least one (e.g., one or two) layer-stacked PCB. As may be understood and appreciated by the skilled person, the term “layer-stacked” used herein may generally mean that each of the one or more PCBs may comprise one or more (sub-) layers being stacked together. Some of the possible examples for such “layer-stacked” PCB implementation will be discussed in more detail below. In addition, in some possible exemplary PCB arrangements, e.g., where two PCBs are provided, the PCBs may be arranged in any suitable manner, such as being stacked together, placed apart with a predetermined distance therebetween, or the like.

The inductive sensor assembly may further comprise a sensor chip component element. Generally speaking, the sensor chip component element may be understood to collectively comprise any suitable electronic, electric, mechanical (or in any other suitable form) component that may be considered useful or necessary for implementing the inductive sensor assembly, which may include, but is certainly not limited to, one or more sensor chips (e.g., inductive position sensor/IPS chips) that may be implemented in the form of an integrated circuit (IC) or application-specific integrated circuit (ASIC), and possibly also suitable wiring.

The inductive sensor assembly may yet further comprise a coil system (or sometimes also referred to as a coil arrangement, or the like) comprising one or more sensor coils corresponding to the sensor chip component element. For instance, in some possible implementations of the IPS, the coil system may comprise, among other possibilities, one or more transmit coils and one or more receive coils that are used jointly to determine the position (e.g., the absolute position of the target). In some possible examples, when there are two (or more) sensor chips (e.g., two IPS ICs), there may also be implemented two (or more) (sub-)sets of coils each corresponding to a respective sensor chip. Of course, as can be understood and appreciated by the skilled person, the coil system may be implemented in any suitable manner, depending on various applications and/or circumstances.

More particularly, the sensor chip component element and the coil system may be arranged on opposite sides of the PCB arrangement. That is to say, the sensor chips (possibly with any other electric/electronic elements/components, e.g., capacitors, resistors, etc.) may be arranged on two opposite sides of the PCB arrangement away from each other. As an illustrative (non-limiting) example, assuming that the PCB arrangement comprises one layer-stacked PCB, the sensor chip component element may be arranged/placed on the top side/surface (layer) of the PCB, while on the other hand, the coil system may be arranged/placed on the bottom side/surface (layer) the PCB, or vice versa, such that the sensor chip component element and the coil system are arranged/placed away from each other (or put differently, not on the same layer/surface of the PCB arrangement).

Configured as proposed above, broadly speaking, the present disclosure generally proposes to place all the sensor-related components in the same PCB area but on the opposite side of the sensing element (i.e., the coil system), which would then be able to eliminate the need of the extra space outside of the coil area (for example in conventional implementations). Thereby, overall space and accordingly the cost in the final application may be saved, simply by reducing the PCB size and the necessary space in the equipment housing. As a result, inductive sensors (e.g., IPS) may be designed and/or manufactured in a compact and space efficient manner, which may be considered beneficial for further implementations, such as encoder, true resolver replacement applications, or the like.

In some embodiments, the sensor chip component element may be arranged on a so-called component placement side or layer (i.e., the side or layer where all components/elements of the sensor assembly are placed) of the PCB arrangement. On the other hand, the coil system may be arranged on a so-called coil placement side or layer (i.e., the side or layer where all coils of the sensor assembly are placed) of the PCB arrangement away from the sensor chip component element. In some possible cases, the sensor chip component element may be placed away from the coil system by a predetermined or preconfigured distance. In a broad sense, this distance (or sometimes also referred to as the shielding distance) may generally need to be set carefully, for example in order to maintain sufficient signal strength on the IPS chip's inputs (e.g., that may be calculated or estimated by using any suitable simulation or experiment means).

In some embodiments, the inductive sensor assembly may further comprise a shielding layer (or sometimes also referred to as a shield layer) arranged between the sensor chip component element and the coil system. For instance, the layer-stacked PCB arrangement may comprise a shield layer (e.g., a copper layer, or the like) that is placed between the sensor chip component element and the coil system, such that the sensor chip component element and the coil system could be separated apart from each other.

In some embodiments, the sensor chip component element and the coil system are arranged on separate layers of the layer-stacked PCB. For instance, in some possible cases, the sensor chip component element may be arranged on the top layer of the layer-stacked PCB while the coil system may be arranged on the bottom layer of the layer-stacked PCB, or vice versa. In some other possible cases, the sensor chip component element and the coil system are arranged on two different layers of two layer-stacked PCB s that are stacked together.

In some embodiments, the inductive sensor assembly may be designed or manufactured for implementing an inductive position sensor. Of course, as can be understood and appreciated by the skilled person, the inductive sensor assembly may certainly be extended to any other suitable implementations and/or applications.

In some embodiments, the layer-stacked PCB may be ring or arc-shaped. Such shape may be used in or applied to for example most types of resolver or encoder applications. However, this should not be understood as a limitation of any kind, and any other suitably shaped PCB design may be implemented as well, depending on various requirements and/or applications.

In some embodiments, the inductive sensor assembly may further comprise at least one conductive (e.g., metallic) and rotatory sensor target. In particular, the sensor target may be arranged on the same side of the PCB arrangement as the coil system (e.g., the coil placement side of the PCB), away from the sensor chip component element (e.g., the component placement side). Moreover, as mentioned earlier, the coil system may comprise at least one transmit coil and at least one receive coil arranged for determining the positions of the sensor target during rotation.

In some embodiments, the PCB arrangement may comprise one layer-stacked PCB having at least three (e.g., three, four or more) layers. Accordingly, in some possible cases, the sensor chip component element and the coil system may be respectively arranged on separate outer layers with at least one inner layer in between serving as a shielding layer.

In some embodiments, the layer-stacked PCB may comprise four layers which are arranged as, in a thickness direction, a top outer layer, a top inner layer, a bottom inner layer, and a bottom outer layer. Accordingly, in some possible cases, the sensor chip component element may be arranged on the top outer layer; and the sensor coils of the coil system may be arranged on the bottom inner layer and/or the bottom outer layer. In such cases, there would generally still be one (inner) layer between the sensor chip component element and the coil system that could be seen to serve as a shielding layer.

In some embodiments, a distance between the shielding layer and the coil system may be determined based on a sensing signal strength requirement (e.g., a (pre-determined) minimum sensing receiver signal strength, or the like) of the sensor. As noted above, such sensing signal strength requirement of the sensor may be determined by using any suitable means (e.g., via suitable calculation, simulation, experiment, etc.), as can be understood and appreciated by the skilled person.

In some embodiments, the PCB arrangement may comprise two separate layer-stacked PCBs stacked together. These two PCBs may each have at least one layer (e.g., one or more layers). Accordingly, the sensor chip component element and the coil system may be respectively arranged on the two separate PCBs, away from each other.

In some embodiments, the sensor coils of the coil system may be arranged on a first PCB, while the sensor chip component element may be arranged on a second PCB. In particular, the second PCB may further comprise a shielding layer that is arranged, in a thickness direction, between the sensor chip component element and the coil system, thereby separating the sensor chip component element and the coil system away from each other. As an illustrative (non-limiting) example, the sensor chip component element may be placed on the top layer (side) of the first PCB, while the coil system may be placed on the bottom layer (side) of the second PCB (which itself is stacked below/under the first PCB).

In some embodiments, the PCB arrangement may further comprise a conducting shield, such as a ferrite sheet (or the like), arranged between the two PCBs. Of course, as can be understood and appreciated by the skilled person, any other suitable material or the like may be used here, depending on various implementations and/or applications.

According to another aspect of the present disclosure, there is provided an inductive sensor. Depending on various implementations and/or applications, the inductive sensor may be an inductive position sensor or the like, for example. In particular, the inductive sensor may be implemented based on (e.g., by using) the inductive sensor assembly according to the forgoing aspect as well as any one of the embodiments thereof.

According to yet another aspect of the present disclosure, there is provided a method for manufacturing an inductive sensor assembly (or sometimes also referred to as a sensor design, setup, implementation, or the like).

In particular, the method may comprise providing a printed circuit board (PCB) arrangement comprising at least one layer-stacked PCB. As illustrated above, the term “layer-stacked” as used herein may generally mean that each of the one or more PCBs may comprise one or more (sub-) layers being stacked together. In some possible exemplary PCB arrangements, e.g., where two PCBs are provided, the PCBs may be arranged in any suitable manner, such as being stacked together, placed apart with a predetermined distance therebetween, or the like.

The method may further comprise providing a sensor chip component element. Generally speaking, the sensor chip component element may be understood to collectively comprise any suitable electronic, electric, mechanical (or in any other suitable form) component that may be considered useful or necessary for implementing the inductive sensor assembly, which may include, but is certainly not limited to, one or more sensor chips (e.g., inductive position sensor/IPS chips) that may be implemented in the form of an integrated circuit (IC) or application-specific integrated circuit (ASIC), and possibly also suitable wiring.

The method may yet further comprise providing a coil system comprising one or more sensor coils corresponding to the sensor chip component element. For instance, in some possible implementations of the IPS, the coil system may comprise, among other possibilities, one or more transmit coils and one or more receive coils that are used jointly to determine the position (e.g., the absolute position of the target). In some possible examples, when there are two (or more) sensor chips (e.g., two IPS ICs), there may also be implemented two (or more) (sub-)sets of coils each corresponding to a respective sensor chip. Of course, as can be understood and appreciated by the skilled person, the coil system may be implemented in any suitable manner, depending on various applications and/or circumstances.

Finally, the method may comprise arranging the sensor chip component element and the coil system on opposite sides of the PCB arrangement. That is to say, the sensor chips (possibly with any other electric/electronic elements/components, e.g., capacitors, resistors, etc.) may be arranged on two opposite sides of the PCB arrangement away from each other. As an illustrative (non-limiting) example, assuming that the PCB arrangement comprises one layer-stacked PCB, the sensor chip component element may be arranged/placed on the top side/surface (layer) of the PCB, while on the other hand, the coil system may be arranged/placed on the bottom side/surface (layer) the PCB, or vice versa, such that the sensor chip component element and the coil system are arranged/placed away from each other (or put differently, not on the same layer/surface of the PCB arrangement).

Configured as proposed above, broadly speaking, the present disclosure generally proposes to place all the sensor-related components in the same PCB area but on the opposite side of the sensing element (i.e., the coil system), which would then be able to eliminate the need of the extra space outside of the coil area (for example in conventional implementations). Thereby, overall space and accordingly the cost in the final application may be saved, simply by reducing the PCB size and the necessary space in the equipment housing. As a result, inductive sensors (e.g., IPS) may be designed and/or manufactured in a compact and space efficient manner, which may be considered beneficial for further implementations, such as encoder, true resolver replacement applications, or the like.

In some embodiments, the sensor chip component element may be arranged on a so-called component placement side or layer (i.e., the side or layer where all components/elements of the sensor assembly are placed) of the PCB arrangement. On the other hand, the coil system may be arranged on a so-called coil placement side or layer (i.e., the side or layer where all coils of the sensor assembly are placed) of the PCB arrangement away from the sensor chip component element. In some possible cases, the sensor chip component element may be placed away from the coil system by a predetermined or preconfigured distance. In a broad sense, this distance (or sometimes also referred to as the shielding distance) may generally need to be set carefully, for example in order to maintain sufficient signal strength on the IPS chip's inputs (e.g., that may be calculated or estimated by using any suitable simulation or experiment means).

In some embodiments, the method may comprise providing and arranging a shielding layer between the sensor chip component element and the coil system. For instance, the layer-stacked PCB arrangement may comprise a shield layer (e.g., a copper layer, or the like) that is placed between the sensor chip component element and the coil system, such that the sensor chip component element and the coil system could be separated apart from each other.

In some embodiments, the sensor chip component element and the coil system are arranged on separate layers of the layer-stacked PCB. For instance, in some possible cases, the sensor chip component element may be arranged on the top layer of the layer-stacked PCB while the coil system may be arranged on the bottom layer of the layer-stacked PCB, or vice versa. In some other possible cases, the sensor chip component element and the coil system are arranged on two different layers of two layer-stacked PCBs that are stacked together.

In some embodiments, the inductive sensor assembly may be manufactured for implementing an inductive position sensor. Of course, as can be understood and appreciated by the skilled person, the inductive sensor assembly may certainly be extended to any other suitable implementations and/or applications.

In some embodiments, the layer-stacked PCB may be ring or arc-shaped. Such shape may be used in or applied to for example most types of resolver or encoder applications. However, this should not be understood as a limitation of any kind, and any other suitably shaped PCB design may be implemented as well, depending on various requirements and/or applications.

In some embodiments, the method may further comprise providing at least one conductive (e.g., metallic) and rotatory sensor target. The method may further comprise arranging the sensor target on the same side of the PCB arrangement as the coil system (e.g., the coil placement side of the PCB), away from the sensor chip component element (e.g., the component placement side). Particularly, as mentioned earlier, the coil system may comprise at least one transmit coil and at least one receive coil arranged for determining the positions of the sensor target during rotation.

In some embodiments, the PCB arrangement may comprise one layer-stacked PCB having at least three (e.g., three, four or more) layers. Accordingly, in some possible cases, the arrangement of the sensor chip component element and the coil system may involve respectively arranging the sensor chip component element and the coil system on separate outer layers with at least one inner layer in between serving as a shielding layer.

In some embodiments, the layer-stacked PCB may comprise four layers which are arranged as, in a thickness direction, a top outer layer, a top inner layer, a bottom inner layer, and a bottom outer layer. Accordingly, in some possible cases, the sensor chip component element may be arranged on the top outer layer; and the sensor coils of the coil system may be arranged on the bottom inner layer and/or the bottom outer layer. In such cases, there would generally still be one (inner) layer between the sensor chip component element and the coil system that could be seen to serve as a shielding layer.

In some embodiments, the method may further comprise determining a distance between the shielding layer and the coil system based on a sensing signal strength requirement of the sensor. As noted earlier, such sensing signal strength requirement of the sensor may be determined in any suitable means (e.g., via suitable calculation, simulation, experiment, etc.), as can be understood and appreciated by the skilled person.

In some embodiments, the PCB arrangement may comprise two separate layer-stacked PCBs stacked together. These two PCBs may each have at least one layer (e.g., one or more layers). Accordingly, the arrangement of the sensor chip component element and the coil system may involve respectively arranging the sensor chip component element and the coil system on the two separate PCBs, away from each other.

In some embodiments, the sensor coils of the coil system may be arranged on a first PCB, while the sensor chip component element may be arranged on a second PCB. In particular, the second PCB may further comprise a shielding layer that is arranged, in a thickness direction, between the sensor chip component element and the coil system, thereby separating the sensor chip component element and the coil system away from each other. As an illustrative (non-limiting) example, the sensor chip component element may be placed on the top layer (side) of the first PCB, while the coil system may be placed on the bottom layer (side) of the second PCB (which itself is stacked below/under the first PCB).

In some embodiments, the method may further comprise arranging a conducting shield, such as a ferrite sheet (or the like), between the two PCBs of the PCB arrangement. Of course, as can be understood and appreciated by the skilled person, any other suitable material or the like may be used here, depending on various implementations and/or applications.

Furthermore, according to some example embodiments of the present invention, there may be provided a computer program. The computer program may include instructions that, when executed by a processor, cause the processor to carry out all steps of the example methods described throughout the present disclosure.

Similarly, according to some further example embodiments of the present invention, there may also be provided a computer-readable storage medium. The computer-readable storage medium may store the aforementioned computer program.

Details of the disclosed method can be implemented as systems (e.g., in the form of circuitry) adapted to execute some or all of the steps of the method, and vice versa, as the skilled person will appreciate. In particular, it is understood that methods according to the disclosure relate to methods of operating the systems (or circuitry) according to the above embodiments and variations thereof and that respective statements made with regard to the systems (or circuitry) likewise apply to the corresponding methods, and vice versa.

It is also understood that in the present document, the term “couple” or “coupled” refers to elements being in electrical communication with each other, whether directly connected e.g., via wires or in some other manner (e.g., indirectly). Notably, one example of being coupled is being connected.

### BRIEF DESCRIPTION OF THE DRAWINGS

Example embodiments of the disclosure are explained below with reference to the accompanying drawings, wherein like reference numbers indicate like or similar elements, and wherein

FIG. 1 schematically illustrates an example of a possible implementation of an inductive position sensor setup,

FIGS. 2A and 2B schematically illustrate some examples of possible target designs for implementing various inductive position sensors,

FIG. 3 schematically illustrates, in a (semi-transparent) top view, some exemplary implementations of an inductive sensor assembly according to embodiments of the present disclosure,

FIG. 4 schematically illustrates, in various views, an exemplary implementation of an inductive sensor assembly according to embodiments of the present disclosure,

FIG. 5 schematically illustrates, in a cross-section view, an exemplary implementation of an inductive sensor assembly according to embodiments of the present disclosure,

FIG. 6 schematically illustrates, in a cross-section view, another exemplary implementation of an inductive sensor assembly according to embodiments of the present disclosure,

FIGS. 7 and 8 schematically illustrate, in various views, some possible examples of various implementations of an inductive sensor assembly according to embodiments of the present disclosure, and

FIG. 9 is a flowchart schematically illustrating an example of a method for manufacturing an inductive sensor assembly according to embodiments of the present disclosure.

### DETAILED DESCRIPTION

As indicated above, identical or like reference numbers in the present disclosure may, unless indicated otherwise, indicate identical or like elements, such that repeated description thereof may be omitted for reasons of conciseness.

Broadly speaking, techniques related to inductive sensors or inductive sensor assembly are widely used in various technologies, e.g., in automotive fields. Therein, particularly within the technical context of the present disclosure, inductive position sensors may be considered reasonably popular, generally because of their robustness against environmental influences. Especially for through-shaft applications, the inductive sensors may be considered attractive because of the design flexibility in coil design, which generally allows for relatively easy adaptation for example for on-axis and off-axis position sensing applications.

Even though these benefits may in some cases be seen as a big advantage in many industrial or automotive applications, often for such as industrial or robotics applications, a higher output resolution would be needed which only one absolute inductive position sensor might not be capable of. In addition, some automotive applications may require absolute high-resolution sensors as well, like steering sensors or sensors for wheel hub traction motors, etc.

In view thereof, in a broad sense, the present disclosure generally proposes techniques and/or mechanisms for improvement in design and/or manufacturing of inductive sensor assembly, and more particularly, in a compact and space efficient manner.

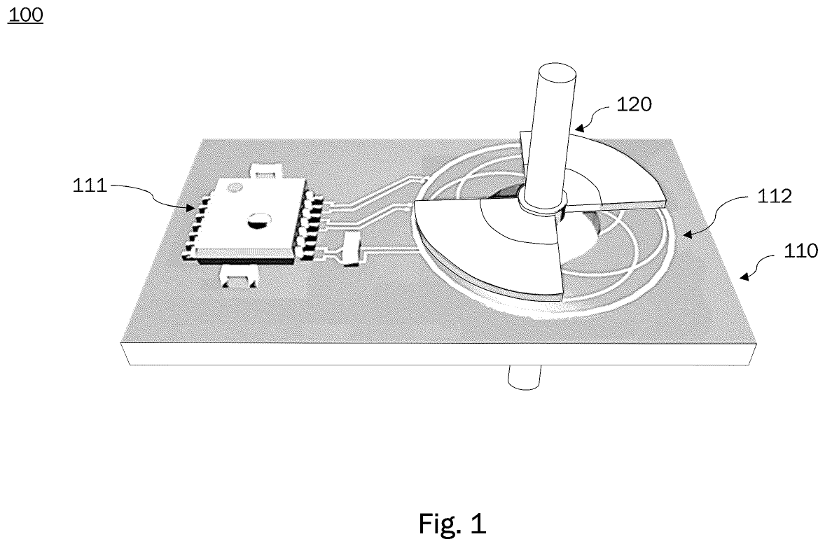

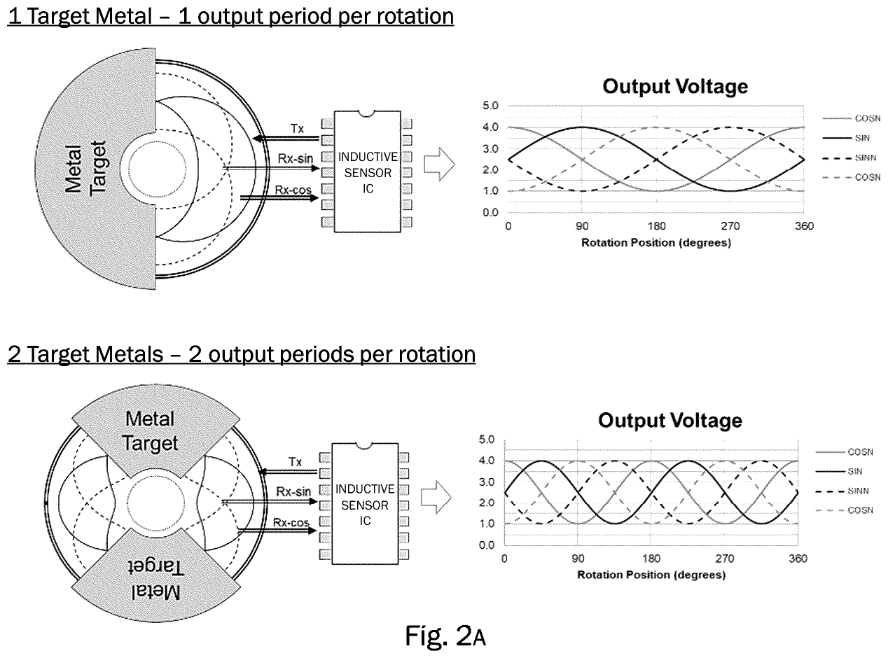

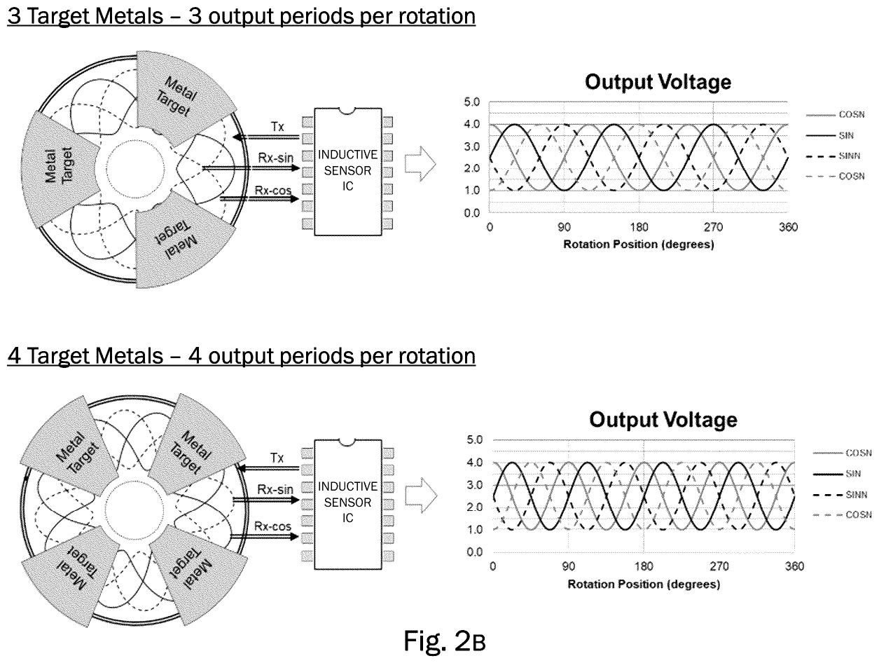

Before going into detail about possible example embodiments of the present disclosure, it may be worthwhile to first give a brief introduction for a typical (conventional) inductive position sensor setup (FIG. 1), and correspondingly also some possible working principles thereof (FIGS. 2A and 2B). Of course, any other suitable design or arrangement for an inductive position sensor may be feasible as well and may (slightly or significantly) deviate from the examples of FIGS. 1, 2A and 2B, depending on implementations and/or applications.

In particular, as exemplarily shown in FIG. 1, the inductive position sensor setup 100 may comprise (but is certainly not limited thereto) a sensor printed circuit board (PCB) 110 placed inside a (e.g., plastic, metallic, etc.) housing (not explicitly shown in the example of FIG. 1) and a conductive target (e.g., a metal target) 120 moving (rotating) near the sensor.

The sensor PCB 110 may include a signal conditioning and processing unit (which may sometimes also be referred to as the sensor chip or sensor chip component, or the like). Such unit/chip may usually be implemented as an integrated circuit (IC) or an application-specific integrated circuit (ASIC). The sensor PCB 110 may also comprise a sensor coil system 112 connected to the ASIC 111, for example via suitable wiring arrangement therebetween. Of course, as can be understood and appreciated by the skilled person, the sensor PCB 110 may also comprise any other suitable electric/electronic element/component, e.g., capacitor, resistor, etc., that may be considered appropriate or necessary for the implementation of the inductive (position) sensor assembly.

Depending on various implementations and/or applications, the sensor coil system 112 may comprise one or more transmit coils and/or one or more receive coils. In a typical design, there may be one transmitter coil and two receiver coils. In such case, the two receiver coils may be arranged such that, for every 360° mechanical rotation of the target 120, one may be configured to generate a sine signal while the other may be configured to generate a cosine signal (see for example FIGS. 2A and 2B). This configuration may be seen to provide an absolute position of the target (sometimes may also be referred to as a so-called “absolute embodiment”). By increasing the number of receiver coil pattern over the 360° and an appropriate target configuration (see the various possible implementations as shown in FIGS. 2A and 2B), it is generally possible to increase the mechanical accuracy and resolution of the measurement per rotation, particularly by generating a number of signal repetition equal to the number of physical repetition of the sine and cosine signal repetitions (sometimes may also be referred to as a so-called “multi-period embodiment”). Notably, in such embodiment, the absolute position of the target may get lost (in comparison with the “absolute embodiment”). Details with regard to the arrangements of the targets and their corresponding working principles are generally considered to be readily understandable to the skilled person, such that those details are not repeated here, for the sake of conciseness.

However, as is intuitively shown in FIG. 1, the (conventional) placement of the sensor ASCI chip aside from the target may be considered to unavoidably result in increase of the overall PCB size (accordingly also the housing size).

Therefore, at least one of the main targets of the present disclosure is to address such sizing issue, by proposing an innovative assembly design (also the corresponding manufacturing) that involves, among others, overlapping the absolute embodiment with the multi-period one, in order to increase the mechanical accuracy and resolution without losing the absolute position. As a result, a high-accuracy, high-resolution absolute sensor can be designed (correspondingly also manufactured).

As will become clearer with the detailed description below, in a broad sense, the present disclosure generally proposes to place all sensor chip related components/elements on the opposite side of the sensor coil system/arrangement side. Thereby, such arranged sensor module/assembly may be seen to be able to fit into most types of resolver or encoder housing space of most of the applications. As a result, they may be readily exchangeable without additional undue modifications to the original equipment housing design. Notably, the PCB design and PCB layer stack generally ensure the right operational conditions for the sensor module.

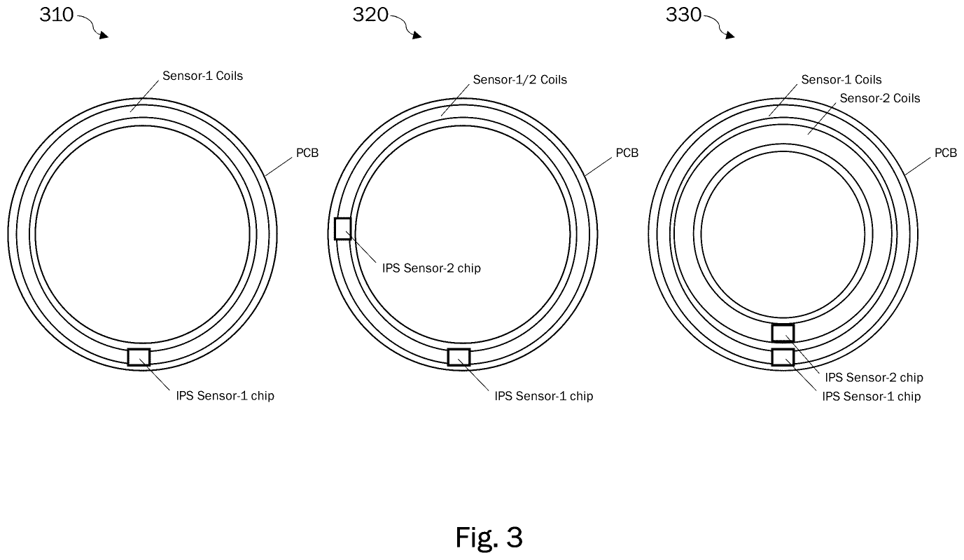

For better understanding, reference is made to FIG. 3, which schematically illustrates, in a (semi-transparent) top view, some (simplified) examples 310, 320 and 330 of an inductive sensor assembly implementation according to embodiments of the present disclosure. Particularly, in the exemplary implementations of FIG. 3, graph 310 generally shows a single coil design, graph 320 generally shows an angle shifted redundant version (e.g., a shifted receive coil serving as a redundancy) of the single coil design, and finally graph 330 generally shows a design with separate or redundant coils next to each other. It is nevertheless to be noted that, these graphs 310, 320 and 330 are illustrated in a (semi-transparent) top perspective, in the sense that, although the coils and sensor chips may appear to be seemingly placed on the same side of the PCB, they are in fact placed—as mentioned above—on opposite sides of the PCB arrangement. For instance, it might be understood that the sensor chips (e.g., the indicated IPS Sensor-1 chip and IPS Sensor-2 chip) may be placed on the top side/layer of the PCB (such that they could be seen directly from the top); whilst the corresponding coils (e.g., the indicated Sensor-1 coil and Sensor-2 coil) may be placed on the bottom side/layer of the PCB (such that they could not be seen directly from the top but only through the PCB, thus the term “semi-transparent” being used).

Configured as proposed above, the implementation according to embodiments of the present disclosure generally allows for a ring-shaped (or arc-shaped) sensor assembly with components below the sensor coils. As a result, the component placement generally does not require any additional PCB space (as compared to the conventional design of FIG. 1). Moreover, the proposed implementation also allows for ring or arc-shapes sensors with possibly the smallest PCB dimensions, for example only depending on the width of the ring (or arc). Accordingly, any suitable design, such as on-axis, through-shaft, side-shaft applications, etc., in a single or redundant implementation, may be made possible, depending on various requirements and/or circumstances. Finally, it is noted that the proposed implementation may also be considered to process high robustness against environmental influences, and at the same time, also immune against magnetic stray fields.

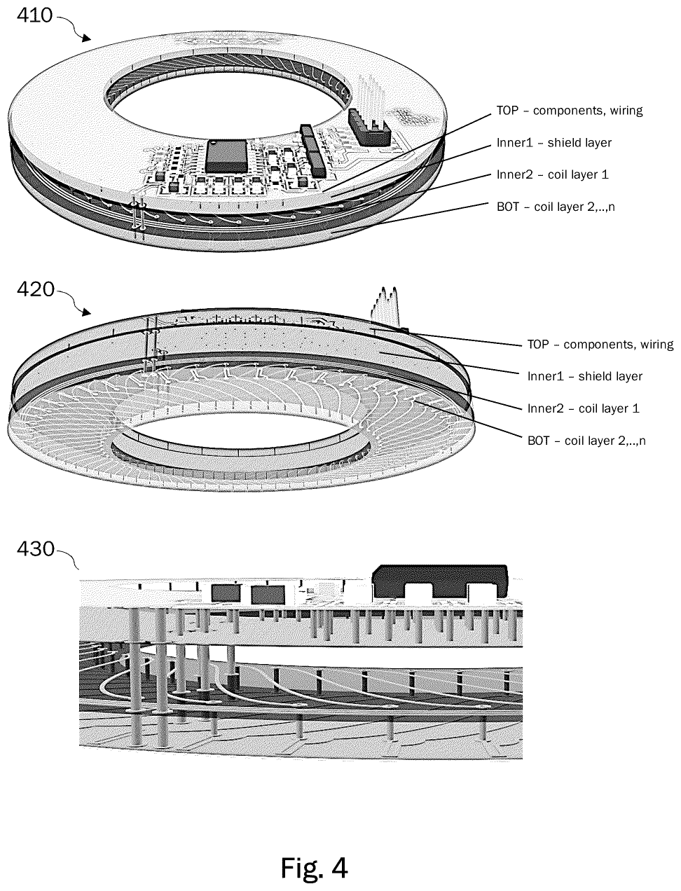

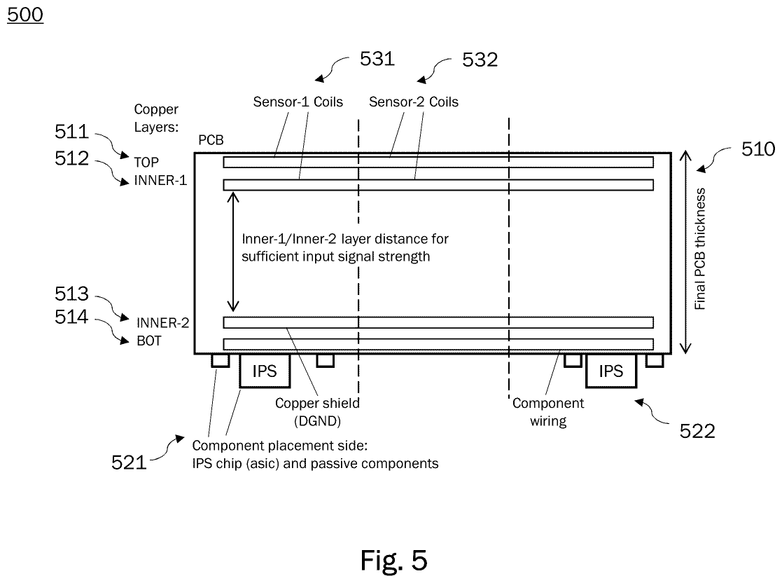

Now, reference is made to FIGS. 4 and 5, where the (simplified) example implementation 330 of FIG. 3 will be described in more detail according to embodiments of the present disclosure. Therein, graph 410 generally shows a slightly angled view from the top, graph 420 generally shows a slightly angled view from the bottom, and finally, graph 430 generally shows a cross-section view from the side.

As illustrated above, the proposed implementation generally allows to place the sensor coils together with the signal conditioning electronic circuits within the same ring shaped (or any other suitable shape) PCB area (however on opposite sides away from each other, as noted above); while at the same time, still being able to maintain good sensing performance.

Specifically, as illustratively shown in the example diagrams 410 and 420 of FIG. 4, the sensor coils (or collectively referred to as a coil system or arrangement) may be placed, depending on various implementations and/or applications, on one or two (or even more) signal layers of the PCB layer stack that are closer to the sensor target (not explicitly shown in the example of FIG. 4), for example in layers as indicated as “BOT” and “Inner2”. Put differently, the sensor target may generally be placed away from the sensor components.

On the other hand, the component placement (possibly also the wiring, or the like) may be arranged on the opposite side of the PCB (for example in the “TOP” layer as schematically shown in graphs 410 and 420).

In some possible implementations, the layer-stacked PCB may also contain a shielding layer (for example in the “Inner1” layer as schematically shown in graphs 410 and 420), thereby separating the sensor components and the sensor coils apart from each other.

Graph 430 schematically shows what a possible exemplary layer stack implementation might look like from the side. It may be worthwhile to mention that, as can be understood and appreciated by the skilled person, such arrangement/implementation of the PCB layers as well as of the sensor components and coils as exemplarily shown in FIG. 4 is merely one possible example for illustrative purposes but should be not understood as a limitation of any kind. For instance, in some possible examples, layers, where the components and the coils are placed, may be simply swapped (e.g., “TOP” layer to “BOT” layer and “BOT” layer to “TOP” layer, or the like).

FIG. 5 schematically illustrates, in a cross-section view, an exemplary implementation of an inductive sensor (e.g., an inductive position sensor or the like) assembly 500 according to embodiments of the present disclosure.

Particularly, the sensor assembly 500 may comprise, among others, a PCB arrangement 510. The PCB arrangement 500 itself may be implemented in a layer-stacked manner. For instance, in the example of FIG. 5, the PCB arrangement may be seen to comprise, in a thickness direction, a TOP layer 511, an INNER-1 layer 512, an INNER-2 layer 513 and finally a BOT layer 514 (similar to those as shown in FIG. 4). These layers may be copper layers, or of any other suitable material.

The sensor assembly 500 may further comprise, on a component placement side, an arrangement of one or more sensor chip component elements 521 and 522, such as the sensor ICs (or ASICs), other suitable (passive) electric/electronic components/elements, or the like.

On the other hand, the sensor assembly 500 may further comprise, on a coil placement side (that is opposite to the component placement side), an arrangement of one or more sensor coils (e.g., transmit coils, receive coils, or the like) 531 and 532. As schematically illustrated in the example of FIG. 5, the sensor coils may be arranged on the same layer (e.g., the TOP layer 511) or on separate layers (e.g., the TOP layer 511 and the INNER-1 layer 512), depending on various implementations and/or applications. It may be worth mentioning that, generally speaking, the exact placement of the sensor chip component elements 521 and 522 on the component placement side may be freely chosen. For instance, the sensor chip component elements 521 and 522 may be placed close or next to each other; below respective sensor coils 531 and 532 or below any of the coils 531 and 532; shifted farther from each other; rotated in any angle, or the like. Also, it is not necessarily required to have shielding between component elements on the same layer, but some suitable distancing (e.g., 2 mm or the like) may be considered.

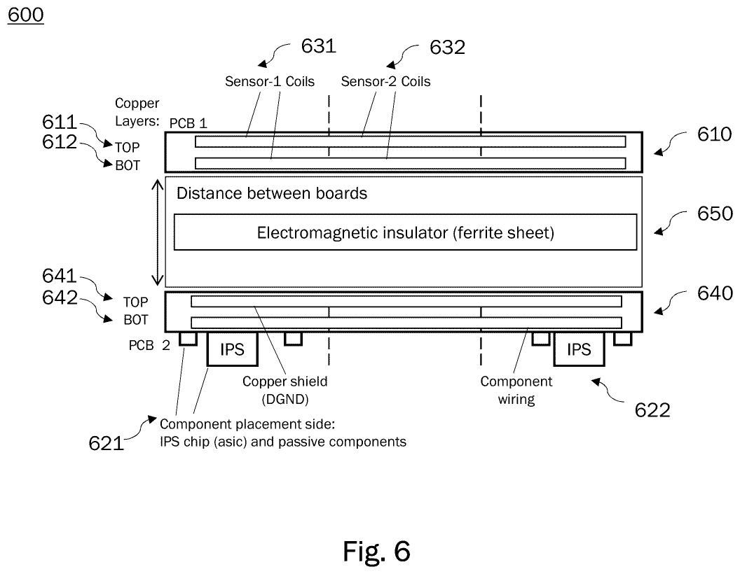

Moreover, as shown in FIG. 5, the sensor assembly 500 may also comprise a shield (e.g., copper) layer 513 (i.e., the INNER-2 layer) that is arranged between the sensor components 521, 522 and sensor coils 531, 532. Notably, the distance between the INNER-1 layer 512 and the INNER-2 layer 513 may be determined or designed in such a suitable manner that generally takes the a sensing signal strength requirement of the sensor into account. Particularly, if the distance between these two layers 512 and 513 becomes too small, the receiving voltage (for determining the positions of the target) of the sensor may be damped. In such a case (e.g., when the sensing or receiving voltage is too low), it may be necessary to increase the distance between layers 512 and 513. In practice, such determination may be made in any suitable means, which may involve, but are not limited to, calculation, simulation, experiment, or the like. As an illustrative example, in some possible scenarios, it is found that a distance of 2.6 mm may result in the sensing/receiving voltage being halved. Moreover, it may also be worthwhile to note that the shield or shielding layer (e.g., the INNER-2 layer 513) may also be generally considered helpful or even necessary for several reasons. One possible reason is that such shielding may (e.g., serving as a Faraday cage) help to reduce both interferences from outside noise onto the sensor signals and also the sensor signals from radiating out and potentially disturbing other devices. Another possible reason is that such shielding may help to make the magnetic field even, because the (metallic) electric components are typically not evenly distributed on the surface/layer of the PCB, which would cause influence in non-linearity in the sensing accuracy. FIG. 6 schematically illustrates, in a cross-section view, another exemplary implementation of an inductive sensor assembly 600 according to embodiments of the present disclosure. Notably, as indicated above, identical or like reference numbers in the example 600 of FIG. 6 may, unless indicated otherwise, indicate identical or like elements in the example 500 of FIG. 5, such that repeated description thereof may be omitted for reasons of conciseness.

To be more specific, in the exemplary assembly 600 of FIG. 6, there may be two separate (layer-stacked) PCBs 610 and 640 that are suitably stacked or coupled together. For instance, in some possible examples, these two PCBs 610 and 640 may be placed in a (plastic) holder. Of course, as can be understood and appreciated by the skilled person, more than two PCBs may also be arranged together, depending on various implementations and/or applications. These two (or more) PCBs 610 and 640 may be collectively referred to as a PCB arrangement, in some possible cases. Particularly, the upper PCB 610 may comprise at least one layer, such as a TOP layer 611 and a BOT layer 612 as shown in the example of FIG. 6. Similarly, the lower PCB 640 may also comprise at least one layer, such as a TOP layer 641 and a BOT layer 642.

Furthermore, similar to that of FIG. 5, one or more sensor chip component elements 621 and 622 (including the sensor ICs, suitable (passive) components/elements, or the like) and one or more sensor coils 631 and 632 may be arranged/placed on different sides (or layers) of the PCBs 610 and 640 away from each other. More specifically, in the example of FIG. 6, the sensor chip component elements 621 and 622 are placed at the component placement side, particularly on the BOT layer 642 of the lower PCB 640. On the other hand, the sensor coils 631 and 632 are placed at the coil placement side, particularly on the TOP layer 611 and/or the BOT layer 612 of the upper PCB 610. Yet, a copper shield may be arranged for example on the TOP layer 641 of the lower PCB 640, thereby separating the sensor coils away from the sensor component elements. Notably, the distance between the two PCBs 610 and 640 may be determined in an analogous or similar manner as illustrated with respect to the distance between the two inner layers 512 and 513 in the example of FIG. 5, such that the respective description is not repeated here for the sake of conciseness.

It may nevertheless be worthwhile to mention that, in some possible implementations, there may also be arranged a conducting shield 650, such as a ferrite sheet (or in any other suitable form) between the two PCBs 610 and 640.

To summarize the above, particularly by being configured as proposed above, the present disclosure generally provides new techniques for designing and/or manufacturing inductive sensors (e.g., inductive position sensors, or any other suitable sensor assemblies) in a compact and space efficient manner, which may be considered particularly applicable to encoder or true resolver replacement applications. Particularly, the proposed techniques save space and overall cost in the final application generally by reducing the PCB size and the necessary space in the equipment housing. More specifically, as has been illustrated above in detail, all the sensor related components in the PCB design are placed on the ring shaped (or in any other suitable shape) PCB on the opposite side of the sensing element which eliminates the need for the extra space outside of the coil area. In some possible implementations, a 4-layer (or more) PCB layer stack design may be used to have a homogenous copper shield on the inner layer between the inner coil design containing layer and the component placement layer.

As such, the proposed technique may generally be considered applicable to all rotary or arc shaped single or redundant coil designs. For instance, depending on various implementations and/or applications, the single coil design may be an absolute or a multi-period design. On the other hand, the redundant coil design may usually be a combination of: (a) single+multi-period coils next to each other (e.g., outer ring, inner ring); (b) identical period count coils with angle shifted placement on the PCB design “on” each other (i.e., one ring) or next to each other (e.g., outer ring, inner ring); and (c) multi-period+one period higher multi-period coils, such as using the Vernier principle coil designs next to each other (e.g., outer ring, inner ring).

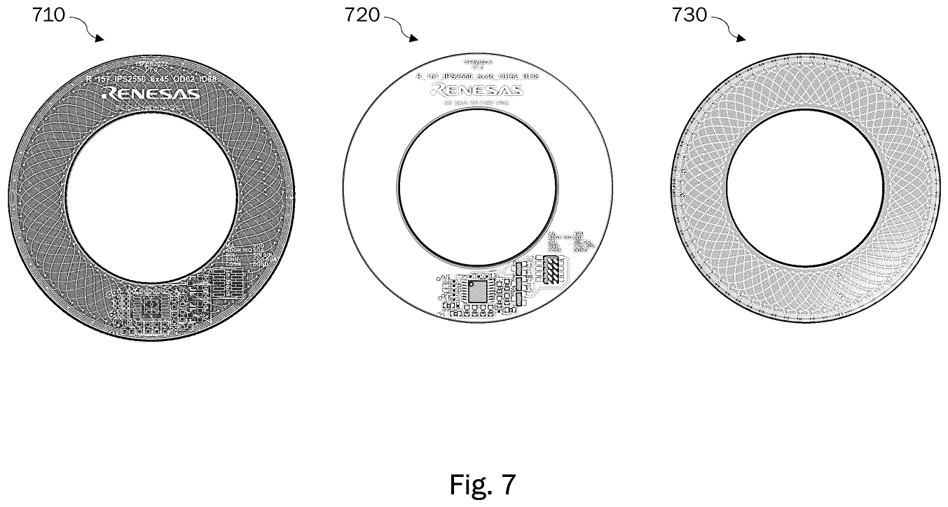

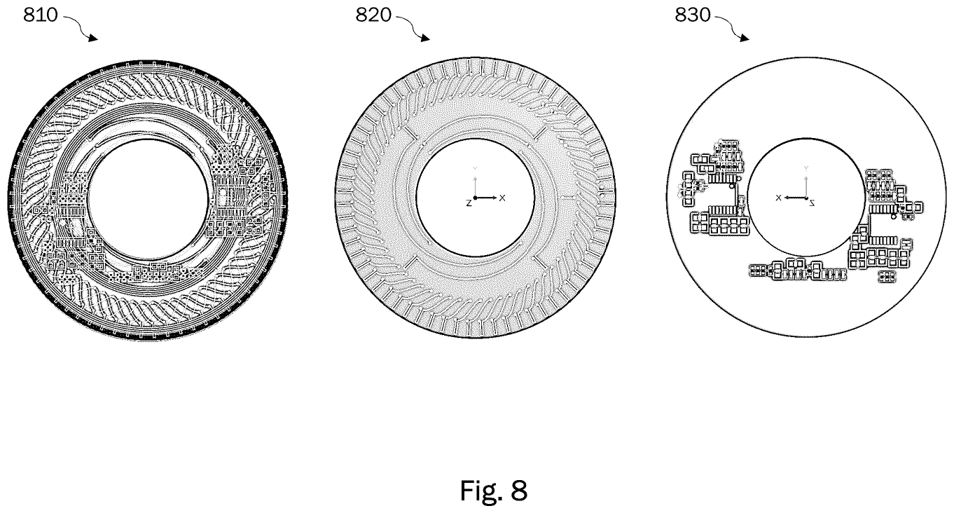

Only to serve as illustrative purposes, FIGS. 7 and 8 schematically show, in various views, some possible (non-limiting) examples of various implementations of an inductive sensor assembly by using the technique proposed according to embodiments of the present disclosure.

In particular, FIG. 7 schematically illustrates a single coil design example (more specifically an 8×45° sensor design). Therein, graph 710 generally shows a PCB layout view. In addition, graph 720 generally shows a sensor top view, where all components are arranged on the TOP layer, the Inner1 layer is a fully filled copper shield, and the copper shield is used as DGND ground. Finally, graph 730 generally shows a sensor bottom view, where the coils are arranged on the Inner2 and BOT layers. In addition, in the example of FIG. 7, blind vias have been used and the overall PCB thickness is around 3.2 mm.

Furthermore, FIG. 8 schematically illustrates a different redundant coil design example (more specifically, an 1×360°+16×22.5° sensor design). Therein, graph 810 generally shows a PCB layout view. In addition, graph 820 generally shows a rendering top view, where the coils are arranged on the TOP and Inner1 layers. Finally, graph 830 generally shows a rendering bottom view, where all components are arranged on the BOT layer, the Inner2 Layer is a fully filled copper shield, and the copper shield is used as DGND ground. In addition, similar to the example of FIG. 7, blind vias have been used and the overall PCB thickness is around 3.2 mm in the example of FIG. 8 as well.

As can be seen from the illustrative examples of FIGS. 7 and 8, particularly by adopting the techniques as proposed in the present disclosure, the overall PCB size (correspondingly also the housing size) can be significantly saved, as compared to conventional techniques.

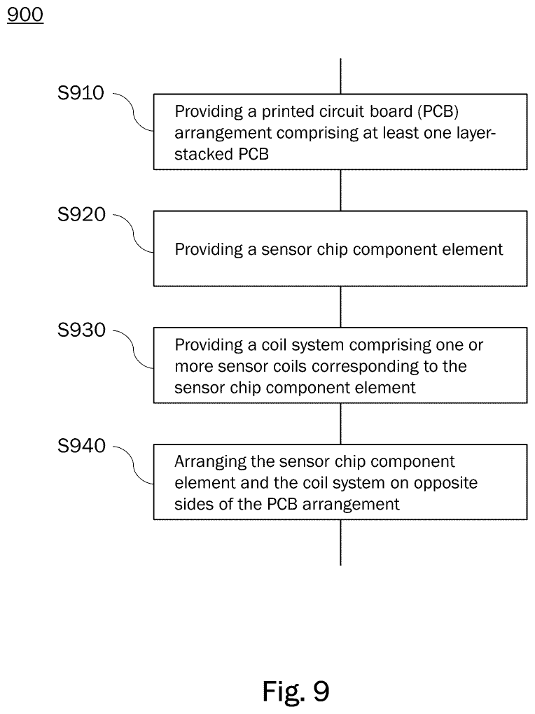

Finally, a flowchart illustrating an example of a method 900 for manufacturing an inductive sensor assembly is schematically shown in FIG. 9. The inductive sensor assembly may be implemented as the inductive sensor assembly 500 in FIG. 5, the inductive sensor assembly 600 in FIG. 6, or the like, for example.

In particular, method 900 may comprise, at step S910, providing a PCB arrangement comprising at least one layer-stacked PCB. Method 900 may further comprise, at step S920, providing a sensor chip component element. Method 900 may yet further comprise, at step S930, providing a coil system comprising one or more sensor coils corresponding to the sensor chip component element. Finally, method 900 may comprise, at step S940, arranging the sensor chip component element and the coil system on opposite sides of the PCB arrangement.

Configured as proposed above, broadly speaking, the present disclosure generally proposes to place all the sensor-related components in the same PCB area but on the opposite side of the sensing element (i.e., the coil system), which would then be able to eliminate the need of the extra space outside of the coil area (for example in conventional implementations). Thereby, overall space and accordingly the cost in the final application may be saved, simply by reducing the PCB size and the necessary space in the equipment housing. As a result, inductive sensors (e.g., IPS) may be designed and/or manufactured in a compact and space efficient manner, which may be considered beneficial for further implementations, such as encoder, true resolver replacement applications, or the like.

It may be worth noting that, the exemplary implementations using inductive position sensors as shown in the figures are merely provided for possible illustrative purposes, but are certainly not to be understood as a limitation of any kind. As can be understood and appreciated by the skilled person, any other suitable sensor arrangement, implementation and/or application may be adopted. The same note goes also with the ring shape. As noted above already, any other suitable shape (e.g., arc, or the like) may be applicable as well, depending on various implementations and/or applications.

It should be noted that the apparatus features described above correspond to respective method features that may however not be explicitly described, for reasons of conciseness. The disclosure of the present document is considered to extend also to such method features. In particular, the present disclosure is understood to relate to methods of operating the circuits described above, and/or to providing and/or arranging respective elements of these circuits.

It is to be further noted that examples of embodiments of the disclosure are applicable to various system configurations, depending on the underlining technical fields. In other words, the examples shown in the above-described figures, which are used as a basis for the above discussed examples, are only illustrative and do not limit the present disclosure in any way. That is, additional further existing and proposed new functionalities available in a corresponding operating environment may be used in connection with examples of embodiments of the present disclosure based on the principles defined.

It should also be noted that the disclosed example embodiments can be implemented in many ways using hardware and/or software configurations. For example, the disclosed embodiments may be implemented using dedicated hardware, dedicated software, and/or hardware in association with software executable thereon. The components and/or elements in the figures are examples only and do not limit the scope of use or functionality of any hardware, software in combination with hardware, firmware, embedded logic component, or a combination of two or more such components implementing particular embodiments of the present disclosure.

Finally, it should be noted that the description and drawings merely illustrate the principles of the proposed circuits and methods. Those skilled in the art will be able to implement various arrangements that, although not explicitly described or shown herein, embody the principles of the invention and are included within its spirit and scope. Furthermore, all examples and embodiment outlined in the present document are principally intended expressly to be only for explanatory purposes to help the reader in understanding the principles of the proposed method. Furthermore, all statements herein providing principles, aspects, and embodiments of the invention, as well as specific examples thereof, are intended to encompass equivalents thereof.

What is claimed is:

1. An inductive sensor assembly comprising:
a printed circuit board, PCB, arrangement comprising at least one layer-stacked PCB;
a sensor chip component element; and
a coil system comprising one or more sensor coils corresponding to the sensor chip component element,
wherein the sensor chip component element and the coil system are arranged on opposite sides of the PCB arrangement.

2. The inductive sensor assembly according to claim 1,
wherein the sensor chip component element is arranged on a component placement side of the PCB arrangement; and the coil system is arranged on a coil placement side of the PCB arrangement away from the sensor chip component element.

3. The inductive sensor assembly according to claim 1, further comprising a shielding layer arranged between the sensor chip component element and the coil system.

4. The inductive sensor assembly according to claim 1,
wherein the sensor chip component element and the coil system are arranged on separate layers of the layer-stacked PCB.

5. The inductive sensor assembly according to claim 1,
wherein the layer-stacked PCB is ring or arc shaped.

6. The inductive sensor assembly according to claim 1,
wherein:
the inductive sensor assembly further comprises at least one conductive and rotatory sensor target;
the sensor target is arranged on the same side of the PCB arrangement as the coil system, away from the sensor chip component element; and
the coil system comprises at least one transmit coil and at least one receive coil arranged for determining positions of the sensor target during rotation.

7. The inductive sensor assembly according claim 1,
wherein:
the PCB arrangement comprises one layer-stacked PCB having at least three layers; and
the sensor chip component element and the coil system are respectively arranged on separate outer layers with at least one inner layer in between serving as a shielding layer.

8. The inductive sensor assembly according to claim 7,
wherein:
the layer-stacked PCB comprises four layers which are arranged as, in a thickness direction, a top outer layer, a top inner layer, a bottom inner layer, and a bottom outer layer;
the sensor chip component element is arranged on the top outer layer; and
the sensor coils of the coil system are arranged on the bottom inner layer and the bottom outer layer.

9. The inductive sensor assembly according to claim 1,
wherein:
the PCB arrangement comprises two separate layer-stacked PCBs stacked together each having at least one layer; and
the sensor chip component element and the coil system are respectively arranged on the two separate PCBs, away from each other.

10. The inductive sensor assembly according to claim 9,
wherein:
the sensor coils of the coil system are arranged on a first PCB;
the sensor chip component element is arranged on a second PCB; and
the second PCB further comprises a shielding layer that is arranged, in a thickness direction, between the sensor chip component element and the coil system.

11. The inductive sensor assembly according to claim 9,
wherein the PCB arrangement further comprises a conducting shield comprising a ferrite sheet, arranged between the two PCBs.

12. An inductive position sensor comprising the inductive sensor assembly according to claim 1.

13. A method for manufacturing an inductive sensor assembly, the method comprising:
providing a printed circuit board, PCB, arrangement comprising at least one layer-stacked PCB;
providing a sensor chip component element;
providing a coil system comprising one or more sensor coils corresponding to the sensor chip component element; and
arranging the sensor chip component element and the coil system on opposite sides of the PCB arrangement.

14. The method according to claim 13,
wherein:
the sensor chip component element is arranged on a component placement side of the PCB arrangement; and
the coil system is arranged on a coil placement side of the PCB arrangement away from the sensor chip component element.

15. The method according to claim 13, further comprising providing and arranging a shielding layer between the sensor chip component element and the coil system.

16. The method according to claim 13, further comprising:
providing at least one conductive and rotatory sensor target; and
arranging the sensor target on the same side of the PCB arrangement as the coil system, away from the sensor chip component element,
wherein the coil system comprises at least one transmit coil and at least one receive coil arranged for determining positions of the sensor target during rotation.

17. The method according to claim 13,
wherein:
the PCB arrangement comprises one layer-stacked PCB having at least three layers;
the arranging the sensor chip component element and the coil system comprises respectively arranging the sensor chip component element and the coil system on separate outer layers with at least one inner layer in between serving as a shielding layer;
the layer-stacked PCB comprises four layers which are arranged as, in a thickness direction, a top outer layer, a top inner layer, a bottom inner layer, and a bottom outer layer;
the sensor chip component element is arranged on the top outer layer; and
the sensor coils of the coil system are arranged on the bottom inner layer and the bottom outer layer.

18. The method according to claim 17, further comprising determining a distance between the shielding layer and the coil system based on a sensing signal strength requirement of the sensor.

19. The method according to claim 13,
wherein:
the PCB arrangement comprises two separate layer-stacked PCBs stacked together each having at least one layer;
the arranging the sensor chip component element and the coil system comprises respectively arranging the sensor chip component element and the coil system on the two separate PCBs, away from each other;
the sensor coils of the coil system are arranged on a first PCB;
the sensor chip component element is arranged on a second PCB; and
the second PCB further comprises a shielding layer that is arranged, in a thickness direction, between the sensor chip component element and the coil system.

20. The method according to claim 19, further comprising arranging a conducting shield including a ferrite sheet between the two PCBs of the PCB arrangement.
